(19) United States
(12) Patent Application Publication
(10) Pub. No.: US 2005/0230593 A1
(43) Pub. Date: Oct. 20, 2005

(54) Christmas tree stand

(76) Inventor: Charlene Wynn, West Valley City, UT (US)

Correspondence Address: MORRISS O'BRYANT COMPAGNI, P.C., 136 SOUTH MAIN STREET, SUITE 700, SALT LAKE CITY, UT, 84101, US

(21) Appl. No.: 10/826,775

(22) Filed: Apr. 16, 2004

(51) Int. Cl. A47G 7/02; F16M 13/00

(52) U.S. Cl. 248/523

(57) ABSTRACT

A Christmas tree stand is structured with a large capacity reservoir for holding comparatively larger amounts of water for hydrating a tree, and is also structured with selectively adjustable legs to adjust the height of the stand relative to a supporting surface, such as a floor. The tree stand is also provided with wheels for allowing movement of the stand and tree into position after the tree has been decorated. The Christmas tree stand may also be configured with adjustable arms for engaging the trunk of the tree, a drainage apparatus for removing water from the reservoir and a viewable window for easily determining the level of water in the reservoir. Also disclosed is a particularly configured water bucket for filling and draining the reservoir of the stand.

### BACKGROUND OF THE INVENTION

1. Field of the Invention

This invention relates to devices for holding Christmas trees in an upright position and specifically relates to an improved Christmas tree stand for decorating and positioning the tree.

2. Description of Related Art

Freshly cut Christmas trees are a main staple of the Christmas season and for centuries people have brought freshly cut trees into their homes for decorating at Christmas time. A variety of means have been employed to maintain the tree in a vertical position. In earlier times, the tree was most conventionally nailed to a wooden structure configured to stabilize the tree in an upright position. However, the cut end of the tree trunk remained exposed to the air, leading to rapid dehydration and death of the tree. In more recent times when Christmas trees have been purchased long before Christmas day and kept for some time after, the dehydration and death of the tree has lead to a very dangerous fire condition.

Therefore, in more recent decades, various tree stands have been developed with the principal objective of keeping the cut end of the tree trunk moist and exposed to a source of water to help keep the tree hydrated and fresh, thereby reducing the fire hazard. Most such tree stands comprise a metal bowl having upstanding spikes for piercing the cut surface of the tree trunk, at least three legs and a means for further securing the tree to the stand in a vertically stabilizing manner. Usually, the vertical stabilizing means comprises a ring which encircles the trunk of the tree and which also engages the upper ends of the legs of the stand.

Known tree stands have a number of disadvantages. Mainly, the bowl portion of the tree stand is shallow and can only hold a small amount of water. Thus, the water in the bowl must be replenished every day or two in order to keep the tree hydrated. Most people quit watering the tree after the first or second refilling of the stand because of the inaccessibility of the stand once a tree skirt and/or presents have been placed about the bottom of the tree. As a result, the tree dries out and becomes a potential fire hazard. Therefore, known tree stands ultimately defeat the purpose for which they were intended.

Additionally, many bowl-shaped tree stands leak or, more often, the tree owner cannot clearly see where the water level is in the tree stand and more water is placed in the bowl of the stand than can be accommodated, thereby leading to a flooding of water on the carpet or floor.

Further, all known tree stands have little or no means for adjusting the height of the stand relative to the floor, and have little or no means for providing height adjustment of the tree. With conventional tree stands, the tree must either be measured very carefully, taking into consideration the height that the stand will add to the tree, to assure that the tree will fit the intended height (usually of the room). More often, the tree is placed in the stand and once positioned, it becomes apparent that the tree is too tall with the additional height of the stand so the tree must be removed again from the stand and a length of the trunk removed before replacing the tree in the stand.

Another disadvantage of all known tree stands is that once the tree is attached to the stand, the tree must be positioned where it will reside for the remainder of the season and then decorating can begin; however, certain portions of the tree (i.e., typically the back portions that are positioned against a wall) are no longer easily accessible for decoration, although those portions are still visible to the viewer. The result can be an unevenly or poorly decorated tree.

Thus, it would be advantageous in the art to provide a Christmas tree stand that is configured to provide an increased means for retaining water, that is easily accessible and determinable as to the water content within the stand, that is vertically adjustable, and which allows movement of the tree into position after the decorations have been placed on all portions of the tree.

### BRIEF SUMMARY OF THE INVENTION

In accordance with the present invention, a Christmas tree stand is configured with a reservoir for containing the fresh cut end of a tree in a comparatively large capacity receptacle for water, the reservoir being easily accessible and viewable to determine the level of water contained in the reservoir at any given time. The Christmas tree stand of the present invention is also configured with height adjustment apparatus for selectively adjusting the height of the stand, and thus the tree. The Christmas tree stand of the present invention is further structured with apparatus for horizontally moving the stand and the tree following the decoration of the tree thereby allowing the tree to be decorated prior to placement in its final position.

The Christmas tree stand of the present invention is further configured with tree engaging apparatus that is structured to secure the tree trunk to the stand and is configured to accommodate virtually any circumferential dimension of a tree. The Christmas tree stand of the present invention may also include apparatus for draining water from the reservoir while the tree is still engaged by the tree stand. To that end, a water bucket is disclosed as part of the Christmas tree stand of the present invention, the water bucket being particularly configured for providing easy access to the reservoir when filling the reservoir of the stand, and being particularly configured to attach to the drainage device of the stand to drain water from the stand.

These and other advantageous elements of the present invention are further disclosed in the drawings and detailed description of the invention that follows.

### BRIEF DESCRIPTION OF THE SEVERAL VIEWS OF THE DRAWINGS

In the drawings, which illustrate what is currently considered to be the best mode for carrying out the present invention:

FIG. 1 is a view in perspective of the Christmas tree stand of the present invention illustrating a tree (shown in phantom) engaged by the stand, a portion of the reservoir being shown in cutaway;

FIG. 2 is a partial perspective view of the Christmas tree stand of the present invention illustrating an alternative device for attaching the arms of the stand to the reservoir;

FIG. 3 is a partial view in cross section of the height adjustment apparatus shown in FIG. 1, taken at line 3-3; and

FIG. 4 is a water bucket particularly configured for use with the Christmas tree stand of the present invention.

### DETAILED DESCRIPTION OF THE INVENTION

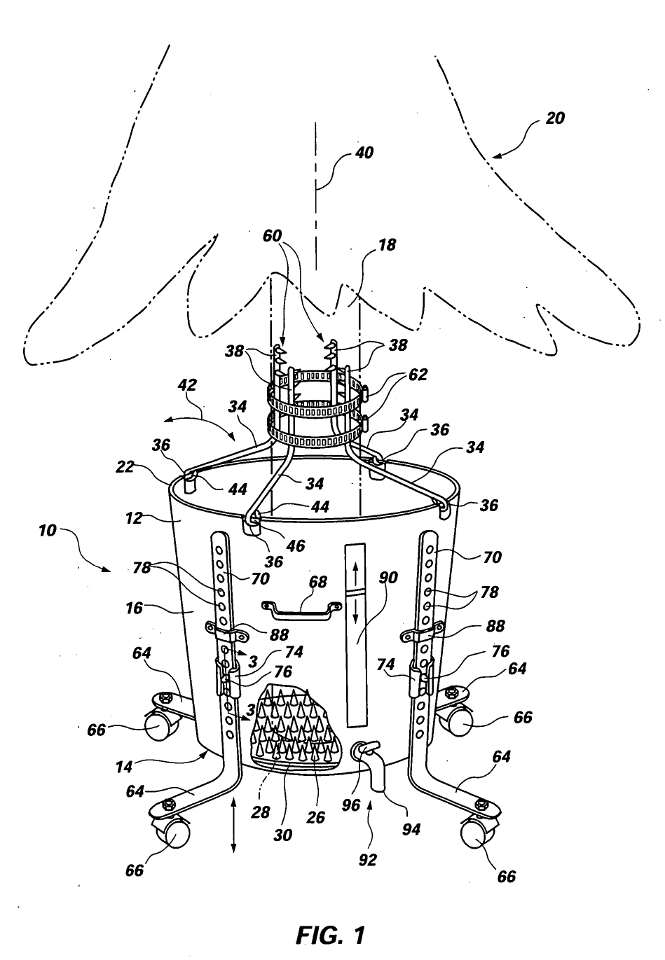

The Christmas tree stand 10 of the present invention, as illustrated in FIG. 1, is generally comprised of a reservoir 12 having a bottom 14 and an upstanding wall 16. The reservoir 12 is structured and sized to receive the trunk 18 of a tree 20 and is sized in volumetric capacity to hold a greater amount of water than is capable in conventional Christmas tree stands. For example, the height of the upstanding wall 16 as measured from the bottom 14 to the upper rim 22 of the reservoir may be from about six inches to about twelve inches or greater, and may have a volumetric capacity of between about 0.25 gallons to about 1.5 gallons.

The reservoir 12 may preferably be structured with at least one tree engaging element 26, such as a sharp spike, for example, which extends from the bottom 14 of the reservoir 12 toward the upper rim 22 of the reservoir 12. As illustrated, the reservoir 12 may have a plurality of tree engaging elements 26 which are positioned to engage and/or pierce the cut end 28 of the trunk 18 of the tree 20. The tree engaging elements 26 may be secured to the bottom 14 of the reservoir 12 or, as shown, may be integrally formed with a plate 30 that is secured to the bottom 14 of the reservoir 12. The plate 30 may, in one embodiment, be removably secured to the reservoir 12.

The stand 10 of the present invention further comprises a plurality of arms 34 which are secured to the reservoir 12 and which are oriented to engage the trunk 18 of the tree 20. In the particular embodiment shown, the arms 34 may each have a first end 36 that is secured to the upper rim 22 of the reservoir 12, and each arm 34 has a second end 38 which contacts and engages the tree trunk 18. The first end 36 of each arm 34 may, most suitably, be pivotally connected to the reservoir 12 so that the arms 34 can be swung outwardly from the central axis 40 of the reservoir 12, in the direction of arrow 42, while the tree 20 is being positioned within the reservoir 12 and on the tree engaging elements 26.

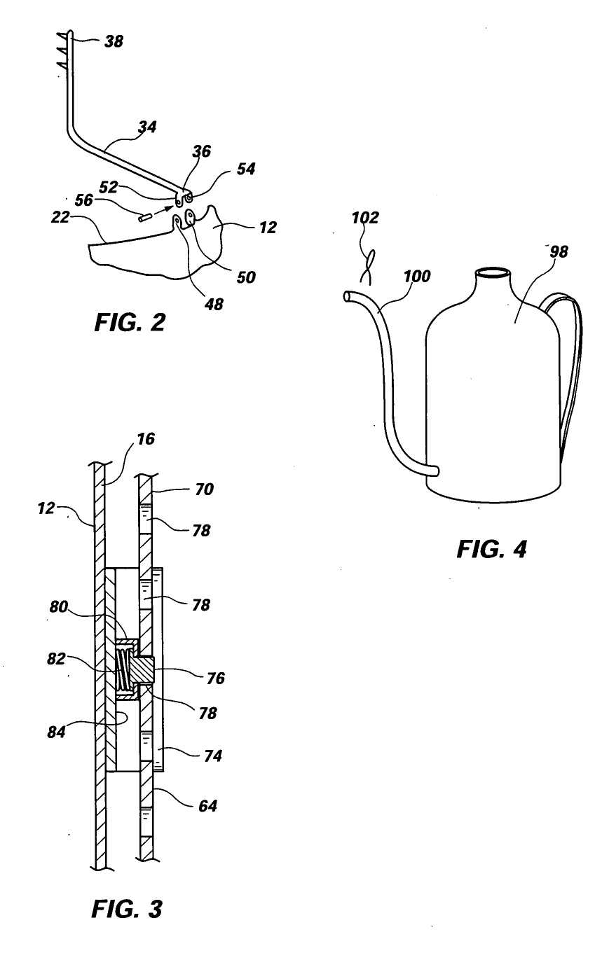

By way of example, the first end 36 of each arm 34 may be formed with a closed loop 44 through which a ring-like member 46 associated with the upper rim 22 of the reservoir 12 is positioned to allow the arm 34 to pivot about the ring-like member 46. In an alternative embodiment, shown in FIG. 2, the upper rim 22 of the reservoir 12 may be formed with a pair of parallel apertured posts 48, 50, and the first end 36 of each arm 34 may be configured with a corresponding pair of parallel apertured braces 52, 54 that are journalled between the apertured posts 48, 50 of the reservoir 12 by the positioning of a pin 56 through the aligned apertures. In the alternative embodiment of FIG. 2, the arms 34 are pivotally joined to the reservoir 12 to allow the arms 34 to be moved away from the central axis of the reservoir 12 while the tree is being positioned in the reservoir 12.

Referring again to FIG. 1, it can be seen that the second end 38 of each arm 34 may be structured with tree engaging apparatus 60, shown here as laterally extending spikes that pierce the trunk 18 of the tree 20 when the arms 34 are rotated into position to contact the tree 20. At least one ring 62 may be provided which is sized to encircle the trunk 18 of the tree 20. The ring 62 is positioned over each of the arms 34 to secure the arms 34 to the trunk 18 to stabilize the tree in its position relative to the tree stand 10. By way of example only, the ring 62 (here shown as having two rings 62) may be circumferentially adjustable to tightly secure the arms 34 in contact with the tree trunk 18. However, any other type of means or device for securing the ring 62 in place against the trunk 18 and/or the arms 34 may be employed to affix the arms 34 to the trunk 18 and stabilize the tree 20 in a vertical position.

The Christmas tree stand 10 of the present invention is further structured with legs 64 that are secured to the reservoir 12. As shown, each leg 64 may preferably have associated therewith a caster-type wheel 66 which allows the Christmas tree stand 10 and the tree 20 to be moved into a final position after the tree 20 has been secured to the stand 10 and has been decorated in a desired fashion. The tree stand 10 may also be structured with a movement device, such as a handle 68, here shown positioned on the reservoir 12, to facilitate horizontal (i.e., along the floor) movement of the stand 10 and tree 20 into a desired position. While a handle provides perhaps the most steadying device for effecting horizontal movement of the stand 10, other devices may include, by way of example only, an apertured bracket attached to the stand that can be grasped by a long handled hook, positionable through the aperture of the bracket, to provide movement of the stand 10.

The legs 64 of the present invention are most suitably vertically adjustable relative to the reservoir 12, thereby allowing the height of the tree 20 and the stand 10, relative to the supporting surface (i.e., the floor), to be selectively adjusted. By way of example only, each leg 64 may be structured with a vertical portion 70 which is positioned in proximity to the upstanding wall 16 of the reservoir 12 and is slidingly movable relative to the upstanding wall 16. The vertical portion 70 of each leg 64 may be slidingly received in a saddle bracket 74 structured with inwardly curved sides that partially enclose the vertical portion 70 of the leg 64.

In the exemplar embodiment shown in FIG. 1, the saddle brackets 74 may be structured with a detent button 76 which is spring-loaded and which is sized to be received in one of a plurality of holes 78 formed along the length of the vertical portion 70 of each leg 64. Thus, as shown more fully in FIG. 3, the saddle bracket 74 may be secured to the upstanding wall 16 of the reservoir 12 and is formed with a detent housing 80 in which is retained a spring 82 biased between the rear wall 84 of the saddle bracket 74 and the detent button 76.

When it is desired to change the vertical position of the leg 64 relative to the reservoir 12, the detent button 76 is pushed inwardly toward the rear wall 84 of the saddle bracket 74 until the button 76 is released from the hole 78 in which it currently resides. The leg 64 may then be moved up or down relative to the reservoir 12 and when the desired position of the leg 64 relative to the reservoir 12 is achieved and a hole 78 is approximately aligned with the button 76, the button 76 is released. The spring 82, biased against the button 76, will cause the button 76 to snap in to the aligned hole 78 to secure the leg 64 in its new vertical position.

Referring again to FIG. 1, the Christmas tree stand 10 may further comprise slot brackets 88 that are secured to the upstanding wall 16 of the reservoir 12 and are positioned in alignment with the vertical portion 70 of each leg 64 to aid in aligning the leg 64 relative to the reservoir 12. The vertical adjustment means described and illustrated herein is but one apparatus or structure for accomplishing height adjustment of the Christmas tree stand 10 relative to a supporting surface (i.e., floor). Many other structures and devices may be employed to accomplish the same intended characteristic of the present invention.

The Christmas tree stand 10 of the present invention may further be structured with a transparent or opaque window 90 formed in the upstanding wall 16 of the reservoir 12 which allows the user to determine the level of water in the reservoir 12. Thus, the water level may be selectively increased or decreased in accordance with the hydration needs of the tree.

The Christmas tree stand 10 of the present invention may also be structured with a drainage device 92 which, as illustrated in FIG. 1, may comprise, by way of example, a spigot 94 and valve 96. The fluid level in the reservoir 12 may be reduced, or the reservoir 12 drained, while the tree 20 is still in position within the reservoir 12. This feature is particularly advantageous since it permits the tidy removal of the tree 20 from the stand 10 when dismantling the tree and prevents spillage of water on the floor. The drainage device 92 is preferably located at a low point of the reservoir 12 near the bottom 14 of the stand 10 to employ the force of gravity in emptying the reservoir 12.

The fluid may be removed from the reservoir 12 most conveniently by using a water bucket 98 especially designed for use with the Christmas tree stand 10. As shown in FIG. 4, an exemplar water bucket 98 is configured with a flexible hose 100 that may be secured to the spigot 94 of the drainage device 92 in a fluid tight manner. The valve 96 of the spigot 94 is then opened to allow the water to drain from the reservoir 12 into the water bucket 98 via the hose 100. The flexible hose 100 of the water bucket 98 also provides a very advantageous means of delivering water to the reservoir 12 once the tree 20 has been positioned in the stand 10. The hose 100 of the water bucket 98 may include a closure device, such as a clip 102, that is removably attachable to the hose 100 to prevent water from exiting the bucket 98.

The Christmas tree stand of the present invention is particularly suited for accommodating fresh cut trees of any size and dimension of trunk, and allows the tree to be adjusted in height via the vertical adjustability of the stand. The Christmas tree stand of the present invention also allows the tree to be decorated and then wheeled into its final position, thereby making decoration of the tree much simpler. While the tree stand is disclosed herein with respect to fresh-cut trees, the stand may be used for artificial trees as well. Moreover, the features of the invention disclosed herein may be effected in a variety of ways using a number of different devices or structures to impart vertical or height adjustment and horizontal movement of the stand along a supporting surface. Thus, reference herein to specific details of the invention are by way of example only and are not meant to limit the scope of the invention.

1. A Christmas tree stand, comprising:
a reservoir structured for receiving a tree and having a compartment for holding water;
legs adjustably secured to said reservoir for selectively adjusting the height of said reservoir relative to a supporting surface; and
movable arms secured to said reservoir and positioned to engage the trunk of a tree to stabilize the tree in a vertical position within said reservoir.

2. The Christmas tree stand of claim 1 further comprising wheels attached to said legs for moving said stand and the tree engaged by said stand.

3. The Christmas tree stand of claim 1 further comprising drainage apparatus positioned on said reservoir for removing water from said reservoir.

4. The Christmas tree stand of claim 1 further comprising a window positioned on said reservoir for viewing the level of water in said reservoir.

5. The Christmas tree stand of claim 1 wherein said movable arms are pivotally rotatable relative to said reservoir.

6. The Christmas tree stand of claim 5 wherein said movable arms have tree engaging apparatus extending from said movable arms and positioned to engage the outer surface of a tree trunk.

7. The Christmas tree stand of claim 1 further comprising at least one ring sized to encircle the trunk of a tree and positioned to secure said movable arms to the tree.

8. The Christmas tree stand of claim 1 further comprising leg brackets secured to said reservoir and structured to movably secure said legs to said reservoir.

9. The Christmas tree stand of claim 8 wherein said leg brackets are structured with detents and wherein said legs are each formed with a plurality of holes sized to be engaged by said detent.

10. The Christmas tree stand of claim 9 further comprising slot brackets secured to said reservoir and positioned to engage a portion of the legs to support said legs in proximity to said reservoir.

11. The Christmas tree stand of claim 1 wherein said reservoir has a movement device secured to said reservoir and positioned to enable horizontal movement of said stand along a supporting surface.

12. A Christmas tree stand, comprising:
a reservoir having a bottom and upstanding wall for holding water;
legs secured to said reservoir;
a wheel connected to each said leg, said wheel being positioned to engage a supporting surface; and
arms attached to said reservoir and positioned to contact the trunk of a tree to vertically stabilize the tree relative to the reservoir.

13. The Christmas tree stand of claim 12 further comprising at least one tree-engaging element extending upwardly from said bottom of said reservoir.

14. The Christmas tree stand of claim 13 further comprising a window positioned through said upstanding wall of said reservoir to view the level of water in said reservoir.

15. The Christmas tree stand of claim 14 further comprising a draining apparatus for removing water from said reservoir.

16. The Christmas tree stand of claim 13 further comprising a device for securing said arms to a tree trunk positioned in said stand.

17. The Christmas tree stand of claim 12 wherein said legs are vertically adjustable relative to said reservoir to selectively adjust the distance between said bottom of said reservoir and a supporting surface for said wheels.

18. The Christmas tree stand of claim 17 wherein said arms are pivotally movable relative to said reservoir and wherein said arms are structured with tree engaging elements.

19. The Christmas tree stand of claim 12 further comprising a flexible hose having one end sized for securement to said drainage apparatus for draining water from said reservoir into a bucket attached to an opposing end of said hose.

20. A Christmas tree stand, comprising:
a reservoir having a bottom and upstanding wall, said reservoir having at least one tree engaging element extending upwardly from said bottom;
height adjustment apparatus secured to said reservoir for selectively adjusting the distance of said reservoir from a supporting floor surface; and
wheels positioned in proximity to said reservoir for moving said reservoir and tree secured in said reservoir.
